(19) United States
(12) Patent Application Publication
(10) Pub. No.: US 2009/0074535 A1
(43) Pub. Date: Mar. 19, 2009

(54) FASTENER ASSEMBLY

(76) Inventors: CHRISTOPHER D. ROBERTS, Joliet, IL (US); Rick G. Lieberman, Streetsboro, OH (US); Robert K. Dutzi, Palatine, IL (US); Jacob Domagalla, Peotone, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 12/199,037

(22) Filed: Aug. 27, 2008

Related U.S. Application Data
(60) Provisional application No. 60/973,551, filed on Sep. 19, 2007.

(51) Int. Cl. F16B 39/00

(52) U.S. Cl. 411/166

(57) ABSTRACT

A fastener assembly configured to secure a component to an interior wall of a housing includes a wall mount configured to securely mount to the interior wall of the housing. The wall mount includes a first plate secured to a second plate through a neck. The first plate has a larger axial cross-sectional area than the second plate, which, in turn, has a larger axial cross-sectional area than the neck. The second plate is configured to pass through a portion of a securing passage formed through the housing. The first plate is larger than the portion of the securing passage, so that the first plate is unable to pass through the securing passage. The wall mount is configured to be rotated into a locked position with respect to the securing passage, wherein the wall mount is prevented from shifting in the locked position.

### RELATED APPLICATIONS

This application relates to and claims priority benefits from U.S. Provisional Patent Application No. 60/973,551 entitled “Fastener Assembly,” filed Sep. 19, 2007, which is hereby incorporated by reference in its entirety.

### FIELD OF EMBODIMENTS OF THE INVENTION

Embodiments of the present invention generally relate to a fastener assembly, and more particularly, to a fastener assembly configured to secure one component, such as an inner drum of a front loading washing machine, to another component, such as a back housing wall of the washing machine.

### BACKGROUND

FIG. 1 illustrates an isometric interior view of a housing 10 securing an inner drum 12 within an interior chamber 14. The housing 10 may be a housing of a washing machine.

The interior chamber 14 is defined by a front wall 16 connected to a base 18, lateral walls 20 and a top wall 22. The base 18, the lateral walls 20 and the top wall 22 are, in turn, connected to a rear wall 24.

The inner drum 12 is secured to the rear wall 24 through a plurality of fastening devices 26 that secure to outwardly-extending arms 28 of the inner drum 12. The fastening devices 26 are generally used during shipping of the housing 10, such as a washing machine, to assist in ensuring that the inner drum 12 is secured within the interior chamber 14. The fastening devices 26 are bolted to the arms 28 extending from the inner drum 12 to secure the inner drum 12 in position with respect to the rear wall 24

FIG. 2 illustrates the rear wall 24 of the housing 10. The rear wall 24 includes a plurality of passages 30 configured to receive the fastening device 26 (shown in FIG. 1). Each passage 30 includes an expanded passage 31 connected to a slot 33. A fastening device 26 is inserted into the passage 31 and shifted over into the slot 33, which is configured to securely engage around the fastening device 26. A hole 32 is positioned proximate each fastener passage 30.

FIG. 3 illustrates a cross-sectional view of a fastening device 26 securing an arm 28 of the inner drum 12 to the rear wall 24 of the housing 10. The fastening device 26 includes a washer 34, a spacer 36 and a bolt 38. The washer 34 includes an inwardly-canted nib 39 that is received and retained within the hole 32. The spacer 36 assists in suspending the inner drum 12 away from the rear wall 24. The bolt 38 is engaged to compressively secure the arm 28 to the rear wall 24, both of which are spaced apart from one another through the spacer 36.

The nib 39 mated into the hole 32 of the rear wall 24 generally keeps the fastener 26 in place with respect to the rear wall 24. However, it has been found that this configuration allows the inner drum 12 to shift and move during shipping. In particular, the nib 39 is susceptible to dislodging from the hole 32, which then allows the fastening device 26 to shift with respect to the passage 30. Consequently, the inner drum 12 may shift within the interior chamber 14. When the inner drum 12 moves within the interior chamber 14, the inner drum 12 can exert improper loading on the bolts 38, thereby warping, bending or snapping the bolts, or otherwise causing them to malfunction.

### SUMMARY OF EMBODIMENTS OF THE INVENTION

Certain embodiments of the present invention provide a fastener assembly configured to secure a component, such as an interior drum of a washing machine, to an interior wall of a housing. The fastener assembly includes a wall mount configured to securely mount to the interior wall of the housing. The wall mount includes a first plate secured to a second plate through a neck. The first plate has a larger axial cross-sectional area (i.e., cross-section about a central longitudinal axis of the fastener assembly) than the second plate, which, in turn, has a larger axial cross-sectional area than the neck. The second plate is configured to pass through a portion of a securing passage formed though the housing. The first plate is larger than the portion of the securing passage, so that the first plate is unable to pass through the securing passage. The wall mount is configured to be rotated into a locked position with respect to the securing passage, wherein the wall mount is prevented from shifting in the locked position.

The wall mount may include at least one knob extending from the first plate. The knob(s) is configured to be engaged to rotate the wall mount into the locked position.

The fastener assembly may also include a cylindrical spacer connected to the second plate. The spacer may snapably secure to the second plate. The fastener assembly may also include an end cap connected to the spacer. The end cap may snapably secure to the spacer. Optionally, the wall mount, the spacer and the end cap may be integrally molded and formed as a single contiguous piece.

The first plate may include one or both of a hose clip and/or a cord clip extending outwardly therefrom. Further, the second plate may include an asymmetrical keying feature configured to mate into a reciprocal notch formed in the securing passage in order to ensure proper positioning of the fastener assembly within the securing passage.

Certain embodiments of the present invention provide a system for securing an interior drum within a housing. The system includes the housing, the interior drum and a plurality of fastening assemblies.

The housing defines an interior chamber and includes a plurality of securing passages. Each of the securing passages includes a rounded end connected to an expanded mid-section, which is in turn connected to a reduced channel, which is in turn connected to a slot that may be perpendicularly oriented with respect to the reduced channel.

The plurality of fastener assemblies are positioned within the plurality of securing passages and securely retain the interior drum with respect to the housing. Each fastener assembly includes a wall mount comprising a first plate secured to a second plate through a neck. The first plate has a larger axial cross-sectional area than the second plate, which, in turn, has a larger axial cross-sectional area than the neck. The second plate is configured to pass through the rounded end and the expanded mid-section so that the neck is within a plane of the securing passage. The first plate is larger than the expanded mid-section. The wall mount is configured to be shifted into the slot through the reduced channel and rotated 90° into a locked position within the slot so that the wall mount is prevented from moving out of the slot. In one embodiment, the centerline of the fastener, such as a bolt, within the fastener assembly is offset with respect to the centerline of the reduced channel, or narrow passageway. Thus, when any force is applied on the fastener in the longitudinal direction of the reduced channel or narrow passageway, the fastener assembly is unable to find its way back through the narrow passageway, thereby locking the fastener assembly in place.

### BRIEF DESCRIPTION OF SEVERAL VIEWS OF THE DRAWINGS

FIG. 1 illustrates an isometric interior view of a housing securing an inner drum within an interior chamber.

FIG. 2 illustrates a rear wall of a housing.

FIG. 3 illustrates a cross-sectional view of a fastening device securing an arm of an inner drum to a rear wall of a housing.

FIG. 4 illustrates an isometric exploded view of a fastener assembly, according to an embodiment of the present invention.

FIG. 5 illustrates an isometric bottom view of a wall mount, according to an embodiment of the present invention.

FIG. 6 illustrates an end view of a wall mount, according to an embodiment of the present invention.

FIG. 7 illustrates a lateral view of a wall mount, according to an embodiment of the present invention.

FIG. 8 illustrates a bottom view of an end cap, according to an embodiment of the present invention.

FIG. 9 illustrates an isometric exploded view of a fastener assembly, according to an embodiment of the present invention.

FIG. 10 illustrates an isometric view of a fastener assembly in relation to a securing passage of a housing, according to an embodiment of the present invention.

FIG. 11 illustrates a front view of a unique securing passage, according to an embodiment of the present invention.

FIG. 12 illustrates an isometric view of a fastener assembly in an initial position in relation to a securing passage of a housing, according to an embodiment of the present invention.

FIG. 13 illustrates an isometric view of a fastener assembly in a final securing position with respect to a securing passage of a housing.

FIG. 14 illustrates an isometric view of a fastener assembly securely positioned within a securing passage of a housing, according to an embodiment of the present invention.

FIG. 15 illustrates a front view of a unique securing passage and securing slots formed through a housing, according to an embodiment of the present invention.

FIG. 16 illustrates an isometric view of a fastener assembly, according to an embodiment of the present invention.

FIG. 17 illustrates a front view of a wall mount of a fastener assembly, according to an embodiment of the present invention.

FIG. 18 illustrates a front view of a spacer of a fastener assembly, according to an embodiment of the present invention.

FIG. 19 illustrates a front view of a securing passage formed in a housing, according to an embodiment of the present invention.

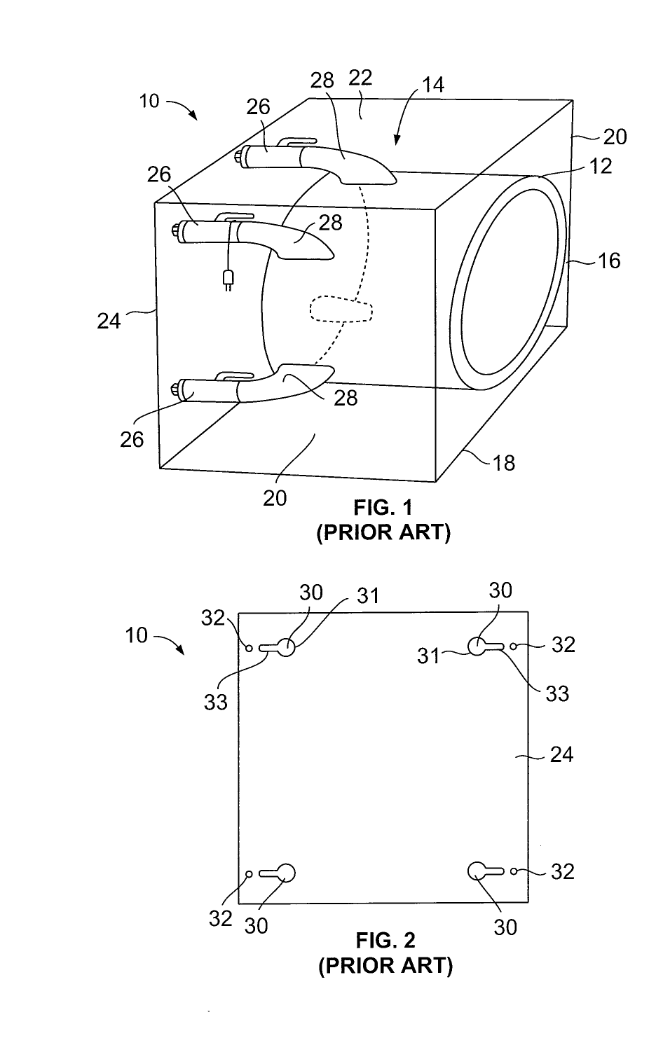

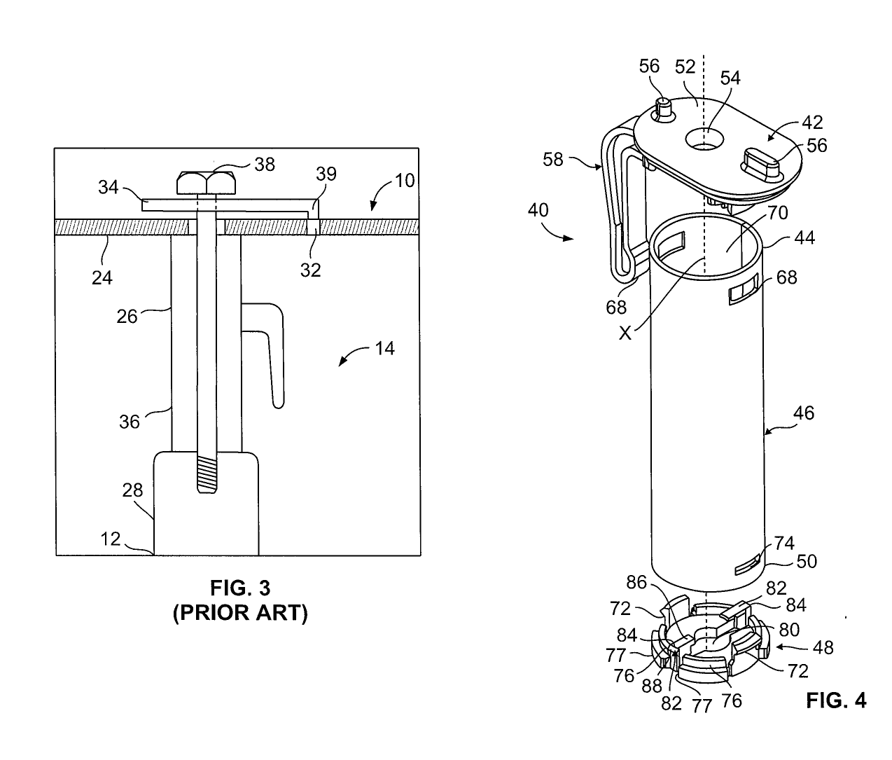

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE INVENTION

FIG. 4 illustrates an isometric exploded view of a fastener assembly 40, according to an embodiment of the present invention. The fastener assembly 40 includes a wall mount 42 that snapably secures to a first end 44 of a spacer 46 and an end cap 48 that snapably secures to a second end 50 of the spacer 46. The fastener assembly 40 is configured to secure a component, such as an inner drum of a washing machine, to a wall of a housing. In particular, the wall mount 42 is retained within a passage formed on the wall and the end cap 48 secures to a distal end of an arm of the inner drum. The spacer 46 suspends the inner drum away from the wall of the housing. The fastener assembly 40 includes a central longitudinal axis x through the wall mount 42, the spacer 46 and the end cap 48.

The wall mount 42 includes a planar upper plate 52 that may be shaped as an expanded oval. A passage 54 is formed through the upper plate 52, while knobs 56 extend upwardly from the plate 52. One knob 56 may be a cylindrical post, while the other may be a rectangular protrusion with rounded ends. In this manner, a user may engage the cylindrical post with a thumb and the rectangular protrusion with an index finger and rotate the wall mount about the cylindrical post by pushing or pulling the rectangular protrusion.

A curved beam 58 extends laterally and downwardly from the wall mount 42 approximately perpendicular to the upper plate 52. The curved beam 58 is configured to securely engage a portion of a power cord (not shown) of a component.

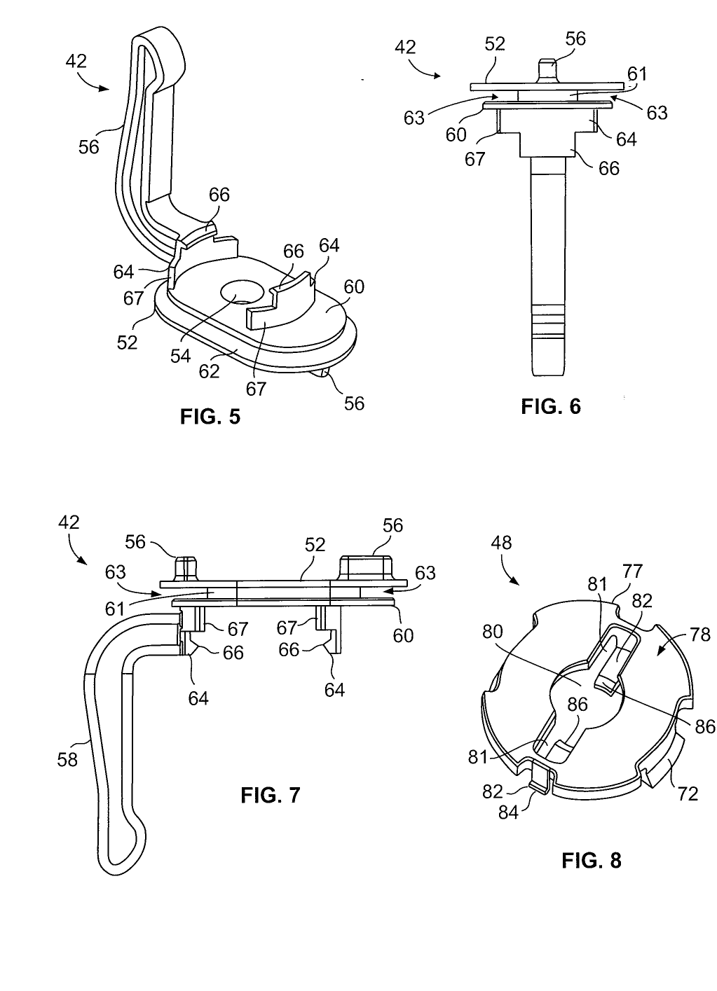

FIG. 5 illustrates an isometric bottom view of the wall mount 42. FIG. 6 illustrates an end view of the wall mount 42. FIG. 7 illustrates a lateral view of the wall mount 42.

Referring to FIGS. 5-7, a reduced plate 60 is integrally connected to the upper plate 52 through a neck 61. An overhanging portion 62 of the upper plate 52 is defined between the outer edge of the reduced plate 60 and the outer edge of the upper plate 52. As shown in FIGS. 6 and 7, in particular, the axial cross-sectional area and circumference of the neck 61 is less than those of either the plate 52 or the plate 60. Further, the axial cross-sectional area and circumference of the plate 60, while larger than those of the neck 61, are both less than those of the plate 52. Clearance gaps 63 extend from a bottom surface of the plate 52 to a top surface of the plate 60.

Opposed spacer securing walls 64 extend downwardly from the reduced plate 60 and are spaced about the passage 54. The walls 64 curve inwardly in general alignment with the curved oval ends of the reduced plate 60. Tabs 66 inwardly extend from lower ends of the walls 64 toward the passage 54.

Referring to FIGS. 4-7, the tabs 66 are configured to be snapably received and retained within slots 68 formed through the first end 44 of the spacer 46. The spacer 46 may be a hollow cylinder, as shown in FIG. 4. The centers of the slots 68 may be 180° apart from one another. The specific arrangement of slots 68 and tabs 66 may differ than that shown. When a bolt is used to compressively secure the wall mount 42 to the first end 44 of the spacer 46, the main portions 67 of the opposed walls 64 may be moved into the slots 68, thereby providing a more secure connection. Thus, the tabs 66 act as a primary securing component, while the main portions 67 of the opposed walls 64 provide a secondary securing component when an associated bolt is tightened to secure the components together.

More or less than two tabs 66 and two slots 68 may be used. Nevertheless, the slots 68 are configured to receive and retain the inwardly-directed tabs 66. That is, the opposed walls 64 fit over the outer surface of the first end 44 of the spacer 46 so that the tabs snap into the slots 68 from the outside of the spacer 46. Optionally, the opposed walls 64 may be configured to fit into an inner channel 70 of the spacer 46 so that the tabs 66 snap into the slots 68 from the inside of the spacer 46. Also, alternatively, the spacer 46 may include the tabs, while slots are formed through the opposed walls 64. Further, while the wall mount 42 is described as snapably securing to the first end 44 of the spacer 46, the wall mount 42 may be secured to the spacer 46 through various other ways, such as bonding, gluing, bolting, latching, clasping or the like.

Also, alternatively, instead of slots and tabs, the wall mount 42 may secure to the spacer 46 through a rib and channel interface. That is, an outwardly directed rib of the wall mount 42 or spacer 46 may securely and rotatably mate into a channel formed in the other of the spacer 46 or wall mount 42. As such, the wall mount 42 may rotate with respect to the spacer 46, and vice versa.

FIG. 8 illustrates a bottom view of the end cap 48. Referring to FIGS. 4 and 8, the end cap 48 is generally circular and is configured to snapably secure into the second end 50 of the spacer 46. The end cap 48 includes two outwardly directed securing tabs 72 that are configured to be snapably retained within slots 74 formed through the second end 50. That is, the end cap 48 fits into the inner channel 70 of the spacer 46 such that the tabs snapably secure into the slots 74, while circumferential walls 76 securely abut into interior surfaces of the spacer 46, such as through an interference fit. Lower stop ledges 77, which collectively form a circumferential cross-section at least equal to that of the spacer 46, provide a flat surface on which the spacer 46 seats. Thus, the end cap 48 is prevented from further receding into the inner channel 70 of the spacer 46. Optionally, the end cap 48 may be configured to be positioned over the second end 50 of the spacer 46.

Also, alternatively, instead of slots and tabs, the end cap 48 may secure to the spacer 46 through a rib and channel interface. That is, an outwardly directed rib of the end cap 48 or spacer 46 may securely and rotatably mate into a channel formed in the other of the spacer 46 or end cap 48. As such, the end cap 48 may rotate with respect to the spacer 46, and vice versa.

Additionally, flashes may be formed over the slots 68 and 74 of the spacer 46. The flashes may allow the tabs to be held in an unlocked position while sliding the fastener assembly 40 into a securing passage of a housing. Once a fastener, such as a bolt, is fully tightened with respect to the fastener assembly 40, the tabs (such as the tabs 86) break through the flashes and lock the components together.

As shown in FIG. 8, in particular, a bottom surface 78 of the end cap 48 is generally flat. Thus, the bottom surface 78 provides a flat surface to interface with an arm of an inner drum.

A channel 80 integrally connected to slots 81, which may be aligned on opposite sides of the channel 80, may be formed through the end cap 46. The channel 80 allows a fastener, such as a bolt, to pass therethrough.

Bolt retaining beams 82 extend over the slots 81. The beams 82 have spacer abutting ends 84 integrally connected to thread engagement ends 86. The ends 84 extend past a diameter defined by the walls 76. When the end cap 48 is positioned in the second end 50 of the spacer 46, the interior surfaces of the spacer 46 slidably engage ramped surfaces 88 of the spacer abutting ends 84. As the end cap 48 continues to be moved into the spacer 46, the spacer 46 forces the spacer abutting ends 84 inward. Consequently, the thread engagement ends 86 also move toward a central axis of the spacer 46. The thread engagement ends 86 are then in position to abut into a shaft of a fastener, such as a threaded bolt. In this manner, the thread engagement ends 86 assist in retaining and properly aligning the bolt.

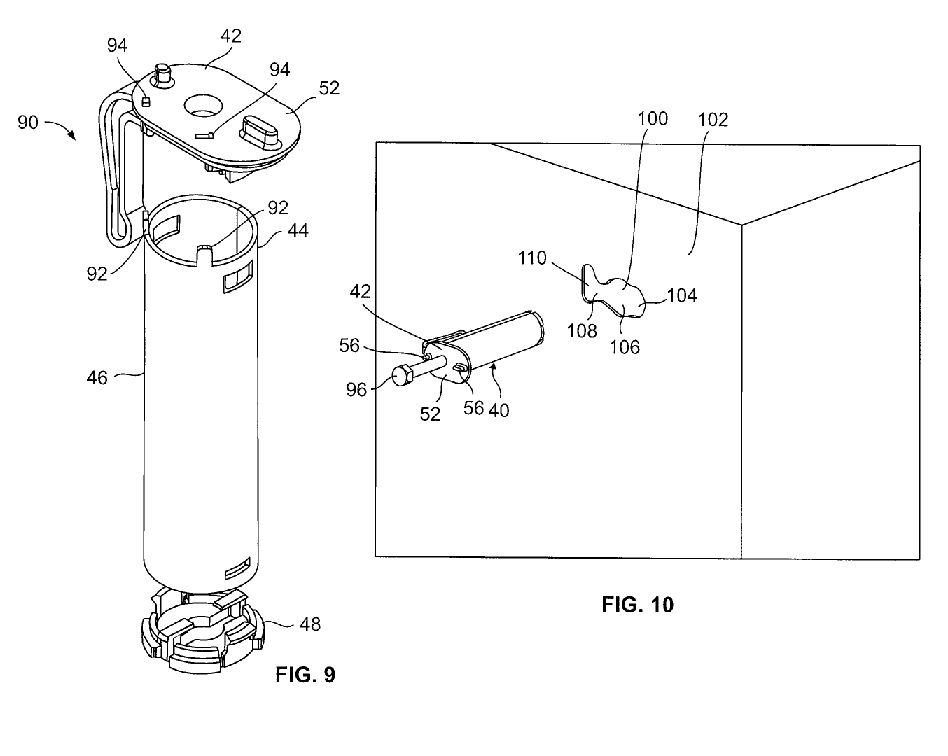

FIG. 9 illustrates an isometric exploded view of a fastener assembly 90, according to an embodiment of the present invention. The fastener assembly 90 is similar to the fastener assembly 40 in that it includes the wall mount 42, the spacer 46 and the end cap 48. However, as shown in FIG. 9, two barbs 92 extend upwardly from an edge of the first end 44 of the spacer 46. The barbs 92 are configured to mate into reciprocal slots 94 formed through the upper plate 52 of the wall mount 42, thereby providing an additional securing feature. When a bolt is tightened, thereby compressing the components of the fastener assembly 90 together, the barbs 92 securely mate into and through the slots 94, so that distal ends of the barbs 92 extend above the upper plate 52.

FIG. 10 illustrates an isometric view of the fastener assembly 40 in relation to a securing passage 100 of a housing 102, according to an embodiment of the present invention. The securing passage 100 is uniquely shaped to receive and retain the fastener assembly 40 (or the fastener assembly 90, shown in FIG. 9).

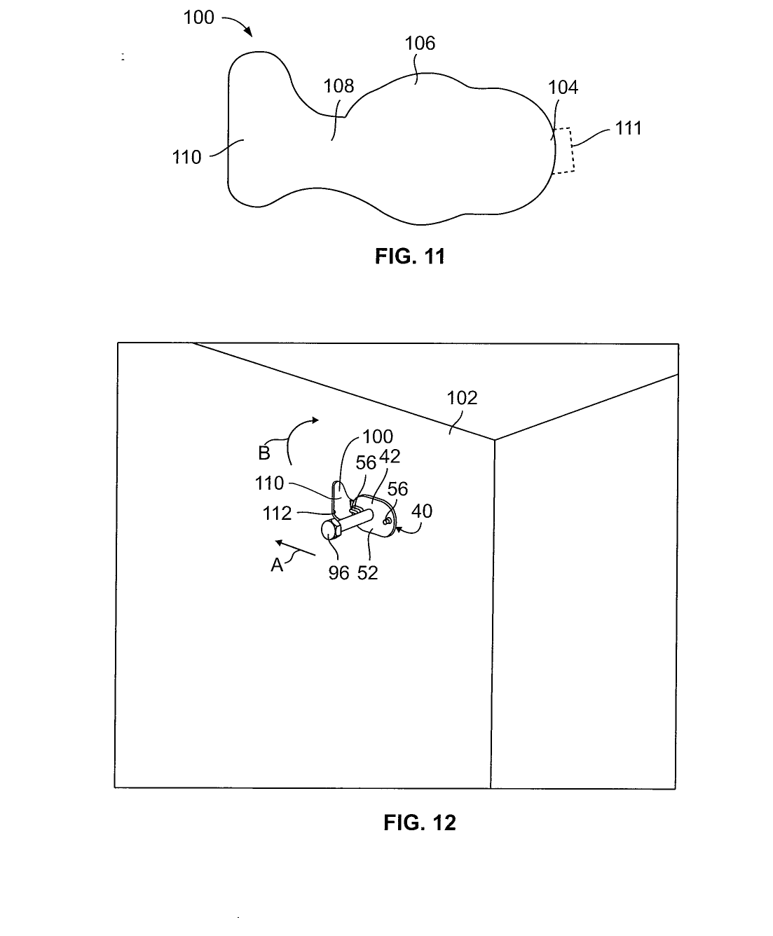

FIG. 11 illustrates a front view of the unique securing passage 100, according to an embodiment of the present invention. The securing passage 100 includes a rounded end 104 having a shape that is slightly larger than the end of the reduced plate 60 (shown in FIG. 5), but smaller than the upper plate 52 (shown in FIG. 5). The rounded end 104 connects to an expanded mid-section 106, which in turn connects to a reduced channel 108. The reduced channel 108 is, in turn, connected to a vertically-oriented slot 110.

An orienting gap 111 may be connected to the rounded end 104. The gap 111 may be configured to receive a locating tab of the wall mount 42 in order to ensure that the fastening assembly 40 is properly aligned within the securing passage 100.

Referring to FIGS. 4-5, 6-7 and 10-11, the fastener assembly 40 is aligned so that the rounded end of the reduced plate 60 opposite the beam 58 is aligned with the rounded end 104 of the passage 100. The remaining portion of the reduced plate 60 is aligned with respect to the mid-section 106, while the beam 58 is aligned with the reduced channel 108. The fastener assembly 40 is then urged into the securing passage 100.

FIG. 12 illustrates an isometric view of the fastener assembly 40 in an initial position in relation to the securing passage 100 of the-housing 102, according to an embodiment of the present invention. Referring to FIGS. 4-5, 6-7 and 10-11, the fastener assembly 40 is passed into the securing passage 100 so that the rounded end of the reduced plate 60 opposite the beam 58 passes through the rounded end 104 of the passage 100, while the remaining portion of the reduced plate 60 passes through the mid-section 106, while the beam passes through the reduced channel 108. In this position, the lower surface of the upper plate 52 abuts against the housing 102. That is, the upper plate 52 is too large to fit through the securing passage 100. Instead, the overhanging portion 62 of the upper plate 52 abuts against a surface of the housing 102 that defines the passage 100. Also, the lower plate 60, as noted above, is on the side of the securing passage 100 opposite the upper plate 52. As such, the neck 61 of the wall mount 42 is generally in the plane of the securing passage 100.

In order to position the fastener assembly 40 into a securing position, the fastener assembly 40 is shifted in the direction of arrow A so that the neck 61 moves into the reduced channel 108 (shown in FIGS. 10 and 11). The reduced channel 108 is large enough to allow the neck 61 to pass therethrough, but too small to allow the lower plate 60 to pass therethrough. Because the lower plate 60 is not in the same plane as the securing passage 100, the fastener assembly 100 may move through the reduced channel 108, by way of the clearance gaps 63 around the neck 61.

The fastener assembly 100 is moved in the direction of arrow A, until the neck 61 abuts against an edge 112 of the housing 102 defining the vertically-oriented slot 110. At this point, a user grasps the knobs 56 and rotates the fastener assembly 40 90° upward in the direction of arc B.

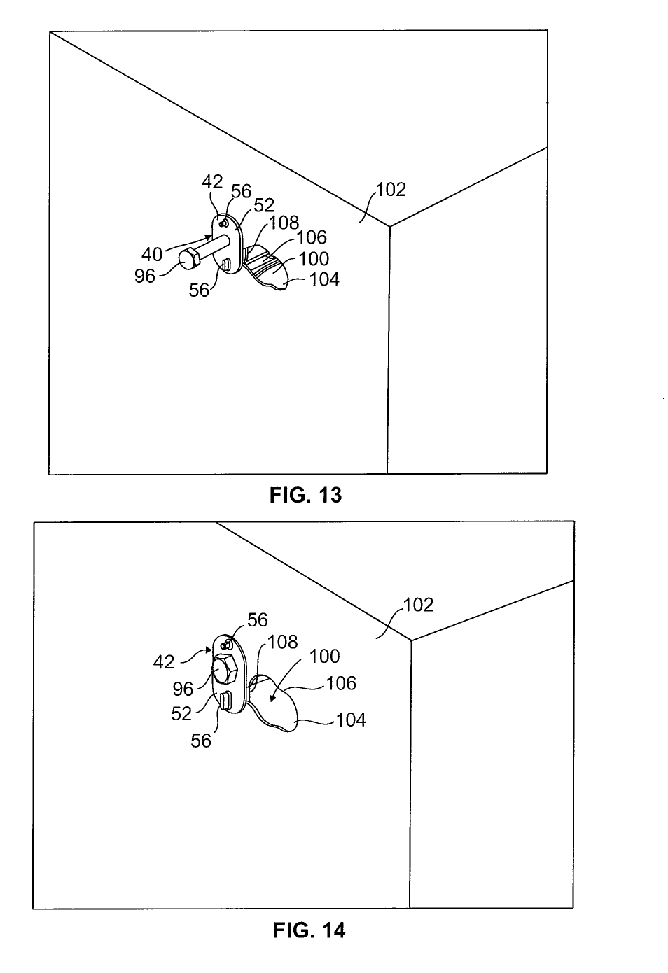

FIG. 13 illustrates an isometric view of the fastener assembly 40 in a final securing position with respect to the securing passage 100 of the housing 102. As shown in FIG. 13, the fastener assembly 40 is rotated upward such that the neck 61 (shown in FIGS. 6 and 7) is entirely within the vertically-oriented slot 110 (shown in FIG. 12), thereby locking the fastener assembly 40 in place with respect to the housing 102. In this position, the bolt 96 is not in horizontal alignment with the reduced channel 108. That is, the bolt 98 is positioned above the reduced channel 108. Further, the vertically-oriented slot 110 may be configured to provide an interference fit with the neck 61 of the wall mount 42, thereby securing the fastener assembly 40 in position with respect to the housing 102.

Additionally, because the bolt 96 is misaligned with respect to the reduced channel 108 (i.e., not able to pass into the reduced channel 108) in this position, the bolt 96 provides a safety barrier that ensures that the wall mount 42 does not eject from the vertically-oriented slot 110. That is, if the fastener assembly 40 begins to shift, the shaft of the bolt 96 will abut against edges that define the upper portion of the vertically-oriented slot 110, thereby preventing further shifting.

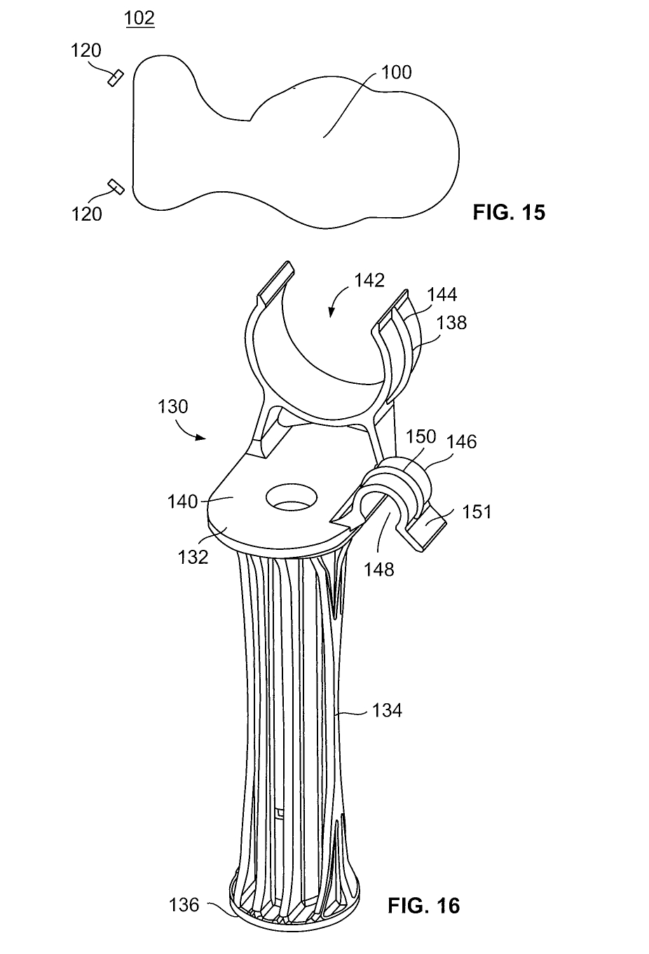

FIG. 14 illustrates an isometric view of the fastener assembly 40 securely positioned within the securing passage 100 of the housing 102, according to an embodiment of the present invention. The bolt 96 is torqued to compressively secure the wall mount 42 to the housing 102 and the end cap 48 (shown in FIGS. 4 and 8) to an arm (not shown) of the inner drum (not shown).

FIG. 15 illustrates a front view of the unique securing passage 100 and securing slots 120 formed through the housing 102, according to an embodiment of the present invention. The securing passage 100 is the same as that described above. The slots 120 are used to receive and retain the barbs 92 that extend through the upper plate 52 of the mounting plate 42 of the fastener assembly 90 in order to provide a further securing interface that locks the fastener assembly 90 in position.

FIG. 16 illustrates an isometric view of a fastener assembly 130, according to an embodiment of the present invention. The fastener assembly 130 may be formed as a single, unitary piece and may include a wall mount 132 integrally connected to a spacer 134 having an expanded end 136.

A hose clip 138 may upwardly extend from an upper plate 140 of the wall mount 132. The hose clip 138 includes an upwardly-directed opening 142 that allows a hose of a device, such as a washing machine, to be securely positioned within the hose clip 138. An outer rib 144 extends over a length of an outer surface of the hose clip 138 and provides strength. That is, the hose clip 138 is flexible and may snapably secure around hoses of varying diameters. The rib 144 ensures the inwardly-directed clamping force of the hose clip 138 remains constant.

A cord clip 146 upwardly and laterally extends from the upper plate 140. However, the opening 148 of the cord clip 146 is directed down (i.e., in an opposite direction as the opening 142 of the hose clip 138). An outwardly-canted lead-in wall 151 extends from an outer end of the cord clip 146 and is configured to allow a user to easily locate the opening 148 and insert a cord therein. The cord clip 146 is flexible so that it may accommodate cords of varying diameters. An outer rib 150 provides strength to the cord clip 146. When the fastener assembly 130 is secured to a housing, the cord clip 146 pins a cord into a secure position against the housing.

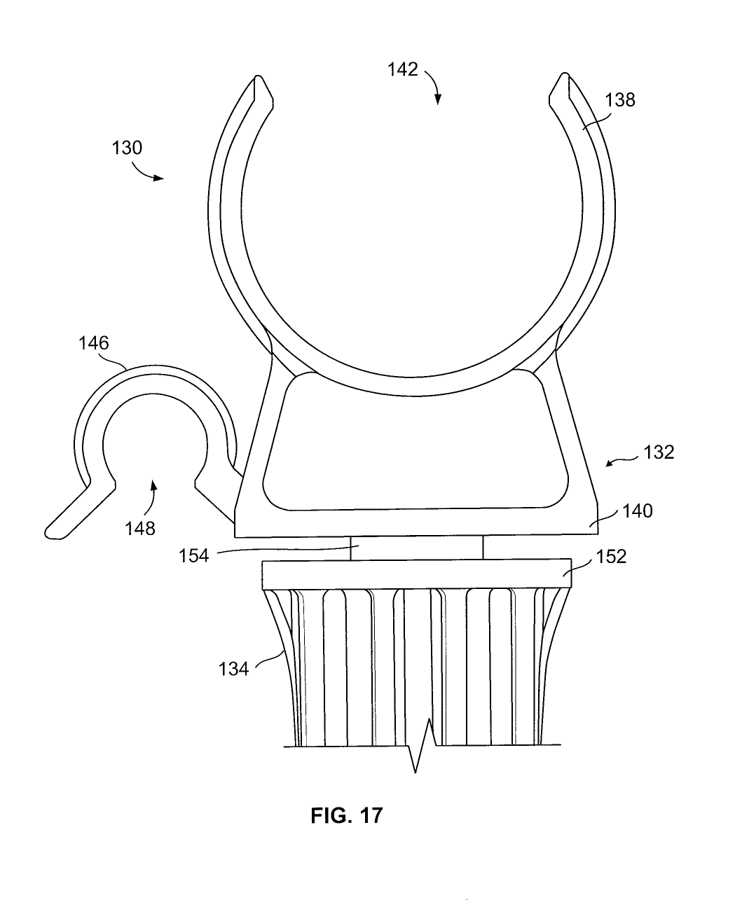

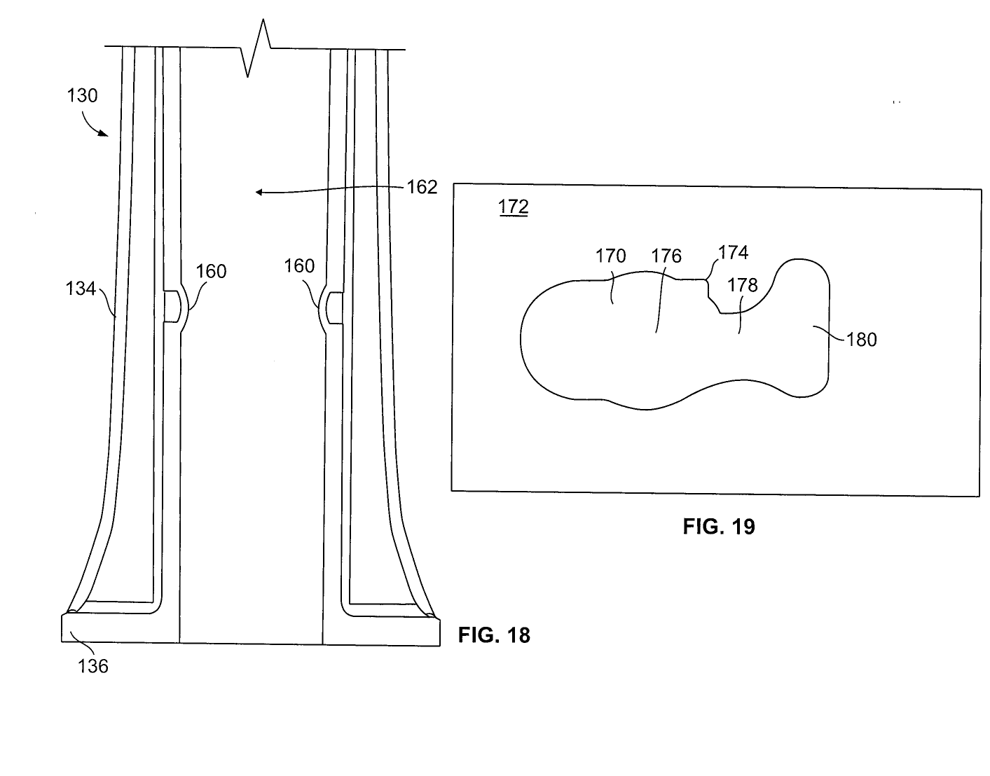

FIG. 17 illustrates a front view of the wall mount 132 of the fastener assembly 130. Similar to the embodiments described above, the upper plate 140 is integrally connected to a lower plate 152 through a reduced neck 154. The lower plate 152 is, in turn, integrally connected to the spacer 134.

FIG. 18 illustrates a front view of the spacer 134 of the fastener assembly 130. The fastener assembly 130 allows a bolt to become a sub-assembly of the fastener assembly 130. In particular, inwardly-directed ribs 160 within an interior fastener passage 162 abut into the shaft of the fastener. As such, the ribs 160 retain the fastener, such as a bolt, within the spacer 134 during shipping and are able to suspend the bolt at a pre-determined height with respect to the spacer 134. In this manner, assembling the fastener assembly 130 to an inner drum is simplified in that an operator does not need to add a separate and distinct bolt.

FIG. 19 illustrates a front view of a securing passage 170 formed in a housing 172, according to an embodiment of the present invention. The securing passage 170 includes a lower plate reception area 176 (e.g., a rounded area and expanded mid-section) connected to a reduced channel 178, which is, in turn, connected to a vertically-oriented slot 180. The lower plate reception area 176 may be sized just large enough to allow the lower plate 152 (shown in FIG. 17) to pass therethrough. That is, the shape of the lower plate reception area 176 is the same as that of the axial cross-section of the lower plate 152, but just large enough to let the lower plate 152 to pass therethrough so that the neck 154 is in the same plane as the securing passage 170 (as described above). The lower plate reception area 176 includes an asymmetrical divot, notch or the like 174 formed into the wall of the housing 170. The notch 174 is configured to allow a similarly-shaped protrusion of the lower plate 152 to pass therethrough. Because the protrusion of the lower plate 152 provides an asymmetry, the notch 174 ensures that the fastener assembly 130 is properly oriented upon insertion.

The fastener assembly 130 shown in FIGS. 16-18 is positioned and locked into place with respect to the housing 170 similar to the embodiments described above. The fastener assembly 130 may be formed as single piece, thereby simplifying the forming process (in that a single mold may be used to form the assembly 130). Also, the fastener assembly 130 is configured to hold a drain hose and cord of a washing machine over a housing wall. Further, the spacer 134 may be integrally connected to the wall mount 132 through a weakened area that may allow the spacer 134 to be broken away prior to machine use. Further, the alignment features of the lower plate reception area 176 of the securing passage 170 and the similarly shaped lower plate 152 prevent misalignment during assembly.

Thus, embodiments of the present invention provide a fastening assembly that securely fastens an aim of a inner drum to a wall of a housing during shipping. Unlike previous fastening devices, the embodiments of the present invention are not susceptible to shifting or slipping. As such, the fastening assemblies remain robust and secure.

Although the embodiments of the present invention are described in connection with a front loading washing machine, the embodiments of the present invention may be used in various other applications. The front loading washing machine is merely described as an example of one such application.

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A fastener assembly configured to secure a component to an interior wall of a housing, the fastener assembly comprising:
a wall mount comprising a first plate secured to a second plate through a neck, said first plate having a larger axial cross-sectional area than said second plate, which, in turn, has a larger axial cross-sectional area than said neck, said second plate being configured to pass through a portion of a securing passage formed though the housing, said first plate being larger than the portion of the securing passage, and said wall mount being configured to be rotated into a locked position with respect to the securing passage, wherein said wall mount is prevented from shifting in the locked position.

2. The fastener assembly of claim 1, wherein said wall mount comprises at least one knob extending from said first plate, wherein said at least one knob is configured to be engaged to rotate said wall mount into the locked position.

3. The fastener assembly of claim 1, wherein said wall mount comprises a fastener passage formed therethrough.

4. The fastener assembly of claim 1, comprising a cylindrical spacer connected to said second plate.

5. The fastener assembly of claim 4, wherein said spacer snapably secures to said second plate.

6. The fastener assembly of claim 4, comprising an end cap connected to said spacer.

7. The fastener assembly of claim 6, wherein said end cap snapably secures to said spacer.

8. The fastener assembly of claim 6, wherein said end cap comprises opposed flexible retaining beams configured to engage a shaft of a fastener.

9. The fastener assembly of claim 6, wherein said wall mount, said spacer and said end cap are integrally molded and formed as a single contiguous piece.

10. The fastener assembly of claim 1, wherein said first plate comprises one or both of a hose clip and/or a cord clip extending therefrom.

11. The fastener assembly of claim 1, wherein said second plate comprises an asymmetrical key configured to mate into a reciprocal notch formed in the securing passage in order to ensure proper positioning of the fastener assembly within the securing passage.

12. A system for securing an interior drum within a housing, comprising:
a housing defining an interior chamber, wherein said housing comprises a plurality of securing passages, each of said plurality of securing passages comprising a rounded end connected to an expanded mid-section, which is in turn connected to a reduced channel, which is in turn connected to a slot that is perpendicular with respect to said reduced channel;
an interior drum having a plurality of arms positioned within said interior chamber; and
a plurality of fastener assemblies positioned within said plurality of securing passages that securely retain said interior drum with respect to said housing, each of said plurality of fastener assemblies comprising:
a wall mount comprising a first plate secured to a second plate through a neck, said first plate having a larger axial cross-sectional area than said second plate, which, in turn, has a larger axial cross-sectional area than said neck, said second plate being configured to pass through said rounded end and said expanded mid-section so that said neck is within a plane of said securing passage, said first plate being larger than said expanded mid-section, and said wall mount being configured to be shifted into said slot through said reduced channel and rotated 90° into a locked position within said slot so that said wall mount is prevented from moving out of said slot.

13. The system of claim 12, wherein said wall mount comprises at least one knob extending from said first plate, wherein said at least one knob is configured to be engaged to rotate said wall mount into the locked position.

14. The system of claim 12, wherein said wall mount comprises a fastener passage formed therethrough.

15. The system of claim 12, comprising a cylindrical spacer connected to said second plate.

16. The system of claim 15, comprising an end cap connected to said spacer, said end cap securing to an end of one of said arms.

17. The system of claim 16, wherein said end cap comprises opposed flexible retaining beams configured to engage a shaft of a fastener that passes through said fastener assembly.

18. The system of claim 12, wherein said first plate comprises one or both of a hose clip and/or a cord clip extending from an outer surface.

19. The system of claim 12, wherein said second plate comprises an asymmetrical key configured to mate into a reciprocal notch formed in one of said plurality of securing passages in order to ensure proper positioning of said fastener assembly within said one of said plurality of securing passages.

20. A fastener assembly configured to secure an inner drum of a washing machine to an interior wall of a housing, the fastener assembly comprising:
a wall mount configured to securely mount to a wall of the housing, said wall mount comprising:
a first plate secured to a second plate through a neck, said first plate comprising one or both of a hose clip and/or a cord clip extending therefrom, said second plate comprises an asymmetrical key configured to mate into a reciprocal notch formed in a securing passage of the housing in order to ensure proper positioning of the fastener assembly within the securing passage,
said first plate having a larger axial cross-sectional area than said second plate, which, in turn, has larger axial cross-sectional area than said neck, said second plate being configured to pass through a portion of the securing passage formed though the housing, said first plate being larger than the portion of the securing passage, said wall mount being configured to be rotated 90° into a locked position with respect to the securing passage, and said wall mount being prevented from shifting in the locked position, wherein said wall mount comprises a fastener passage formed therethrough, said wall mount configured to receive a fastener; and
at least one knob extending from said first plate, wherein said at least one knob is configured to be engaged to rotate said wall mount into the locked position;
a spacer configured to space the inner drum away from the wall of the housing, said spacer comprising first and second ends, a central passage configured to receive the fastener and inwardly directed ribs within said central passage configured to securely engage and align the fastener, said first end connecting to said second plate;
an end cap configured to secure to an arm of the inner drum, said end cap having a fastener outlet passage, said end cap connected to said second end of said spacer, said end cap comprising opposed flexible retaining beams configured to engage a shaft of the fastener.

21. The fastener assembly of claim 20, wherein said wall mount, said spacer and said end cap are integrally molded and formed as a single contiguous piece.
